(19) United States
(12) Patent Application Publication
(10) Pub. No.: US 2019/0360641 A1
(43) Pub. Date: Nov. 28, 2019

(54) A CYLINDER

(71) Applicant: AYGAZ ANONIM SIRKETI, Instanbul (TR)

(72) Inventor: KEREM KADAYIFCIOGLU, Instanbul (TR)

(73) Assignee: AYGAZ ANONIM SIRKETI, Istanbul (TR)

(21) Appl. No.: 16/096,657

(22) PCT Filed: Apr. 27, 2017
(86) PCT No.: PCT/TR2017/050170

§ 371 Date: Oct. 25, 2018

(30) Foreign Application Priority Data
Apr. 29, 2016 (TR) 2016/05611

(51) Int. Cl. F17C 13/00

(52) U.S. Cl. CPC F17C 13/003; F17C 2201/0104; F17C 2201/032; F17C 2205/0165; F17C 2201/058; F17C 2260/028; F17C 2205/0323; F17C 2205/054; F17C 2221/035; F17C 2223/0153; F17C 2250/032; F17C 2205/0308

(57) ABSTRACT

A cylinder is provided in which fluid fuels are stored. The cylinder has at least one body in which a fluid fuel is stored; at least one valve located on the body for conveying fluid fuel into or from the body; at least one handle located on the body; at least one collar connecting the said handle to the body; at least one cover on the valve; at least one identifier located at the inner side of the collar and having thereon at least a first visual code specific to the cylinder it is connected; and at least a second visual code on the cover.

### RELEVANT TECHNICAL FIELD

The present invention relates to cylinders in which fluid fuels are stored.

### BACKGROUND ART

Gaseous fuels such as natural gas, propane, butane, and LPG, a mixture thereof, and the like are fluidized at high pressure so as to be stored in cylinders, and provided to the users. The users use the cylinders they bought by connecting them to ovens, central heating boilers, water heaters, etc. When the gas in the cylinder runs out, the users change the empty cylinder with a filled one. The empty cylinder is sent to a filling plant by the distributor in order to be re-filled, which is, after being filled, provided to the users.

It is of utmost importance for safety to track filling of such re-fillable cylinders, transferring of same from the filling plant to the distributor, selling of same to the users by the distributors, and transferring of empty cylinders obtained from the users to the filling plant by the distributors. If a cylinder is not tracked, the distributor may be subjected to penal sanctions and serious safety problems may be experienced such as refilling of a cylinder and selling to the users by unauthorized persons. Furthermore, in such unauthorized filling processes, different additives may be introduced into the cylinder and the quality of the fuel may be reduced. This not only jeopardizes user safety but also reduces brand value of the original cylinder. Additionally, if the cylinders are not tracked, in case of any safety threats that may occur (i.e. accident, explosion etc.), sufficient information cannot be obtained about the reasons of the situation or the responsibles. Moreover, if the cylinders are not tracked, it is not possible to perform an efficient cylinder stock tracking.

In prior art, as disclosed in US2012187197A1, RFID (Radio Frequency Identification) elements are used for tracking cylinders. However, said RFID elements are expensive and also said elements may easily break down since they are affected by the magnetic field. Given the number of filling of the cylinders and the movements they are subjected while being carried, RFID elements are not preferred for tracking cylinders.

Another example is disclosed in WO2013178891A1, a device to supply pressurized fluid containers which disclose a valve mounted at a port of the pressurized fluid container for controlling the withdrawal and filling of the container, the valve comprising at least one control member for filling and/or withdrawal of the fluid from the container. Said device comprises a valve protection cap mounted on the container and a protective volume around the valve, at least one control member being accessible to a user via an opening in the body of the cap, a frangible guarantee seal which in broken configuration, the seal of guarantee authorizing the use of the control organ by the user and in unbroken configuration the guarantee seal preventing or imitating the use by the user of the said control member. However, said document is silent about the use of visual codes to prevent an unauthorized filling and provides tracking for said containers.

### BRIEF DESCRIPTION OF THE INVENTION

With present invention, a cylinder is provided in which fluid fuels are stored. Said cylinder comprises at least one body in which a fluid fuel is stored; at least one valve located on the body for conveying fluid fuel into or from the body; at least one handle located on the body; at least one collar connecting the said handle to the body; at least one cover on the valve; at least one identifier located at the inner side of the said collar and having thereon at least a first visual code specific to the cylinder it is connected; and at least a second visual code on the said cover.

In the cylinder according to the present invention, since the identifier is located at the inner side of the collar, the first visual code on the identifier is prevented from being damaged. Thus, it is also prevented that the identifier is affected from external factors, thereby rendering it more durable. Moreover, thanks to the second visual code (11) matched with the said first visual code (6), unauthorized filling of the cylinder (T) is also prevented.

### OBJECT OF THE INVENTION

An object of the invention is to;
provide a trackable cylinder;
provide a cylinder with an identifier which is varied for each cylinder,
provide a cylinder whose identifier is durable and long-lasting,
provide a cylinder for which each filling performed in an authorized plant may be tracked,
provide a cylinder for which an unauthorized filling can be detected.

### DESCRIPTION OF THE DRAWINGS

Illustrative embodiments of the cylinder according to the present invention are illustrated in the enclosed drawings, in which:

FIG. 1 is a perspective view of a cylinder.

FIG. 2 is a detailed view of an identifier used in the cylinder.

FIG. 3 is a perspective view of a cover used in the cylinder.

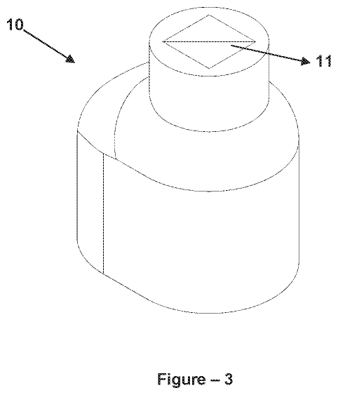

All the parts illustrated in the drawings are individually assigned a reference numeral and the corresponding terms of these numbers are listed as follows:
Cylinder (T)
Body (1)
Valve (2)
Handle (3)
Collar (4)
Identifier (5)
First visual code (6)
Serial number (7)
Brand (8)
Hole (9)
Cover (10)
Second visual code (11)

### DESCRIPTION OF THE INVENTION

Fluid fuels (i.e. fluidized gaseous fuels such as LPG) are stored and provided to the users in cylinders. The cylinders in which gaseous fuels are stored may have different shapes and sizes depending on the area of usage and intended purpose (for example, 2 kg camping cylinder, 12 kg propane cylinder, and 24 and 45 kg industrial cylinder). After the fuel in the said cylinders is consumed, the cylinders can be re-filled by being sent to the filling plants. Tracking of cylinders among the filling plant, the distributor and the user is of utmost importance for safety and stock tracking. Therefore, with the present invention, there is provided a cylinder that may be tracked and unauthorized filling thereof is prevented.

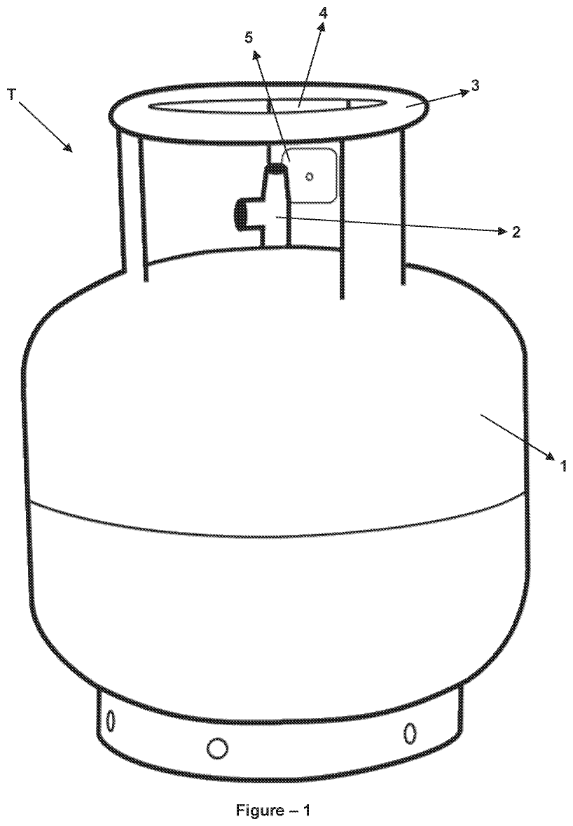

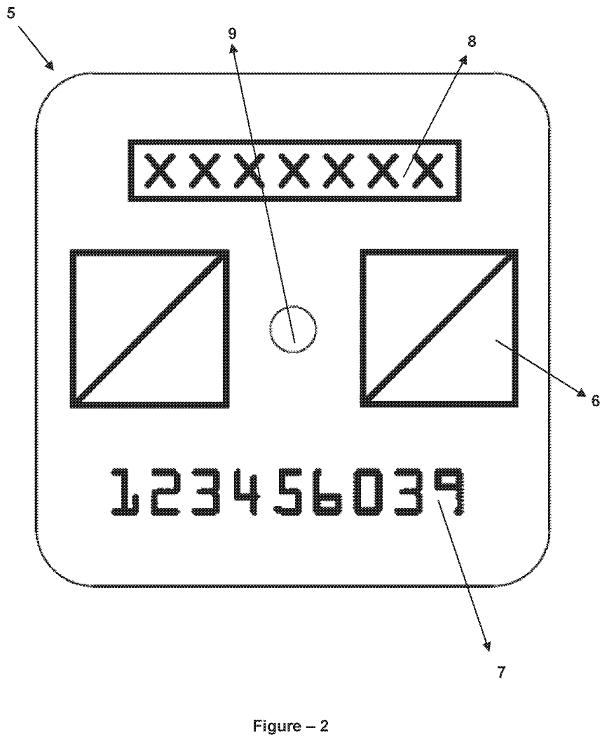

The cylinder (T) according to the present invention, as illustrated in FIG. 1, comprises at least one body (1) in which a fluid fuel is stored; at least one valve (2) located on the body (1) for conveying fluid fuel into or from the body (1); at least one handle (3) located on the body (1), preferably on the periphery of the said valve (2); at least one collar (4) connecting the said handle (3) to the body (1); at least one identifier (5) preferably located at the inner side of the said collar (4) (for example, at that side facing to the valve (2)) and having thereon at least a first visual code (6) specific to the cylinder (T) it is connected; at least one cover (10) on the said valve (2); and at least a second visual code (11) located on the said cover (10) and which is specific to the cylinder (T) it is connected. The first visual code (6) detailed in FIG. 2 serves as an ID of the cylinder (T), and by means of the first visual code (6), such information as serial number, production date, tare, re-filling date and test dates of the cylinder (T) can be achieved.

In an illustrative embodiment of the invention, since the first visual code (6) on the said identifier (5) is read by a reader during the filling of the cylinder (T) according to the present invention, sending of same to the distributor, selling of same to the users, and sending of same to the re-filling plant, tracking of the cylinder (T) may be performed in an easy and efficient manner. Due to the fact that the said identifier (5) is located at the inner side of the collar (4), the first visual code (6) on the identifier (5) is prevented from being damaged due to outer environment, so that the identifier (5) is rendered more durable and long-lasting. The said second visual code (11) is preferably in the form of a code (preferably different from the first visual code (6) to be matched with the first visual code (6). The said matching is performed in the plant where the cylinder (T) is filled. If a user is desirous to use the cylinder (T), the cover (10) on the valve (2) is removed. Therefore, after the cylinder is consumed, the second visual code (11) on the cover (10) cannot be reached by anyone other than the authorized filling plant. In this case, after an unauthorized filling is performed, it is not possible to print a second visual code (11) on the cover (10) matching with the first visual code (6). The user reads the first visual code (6) and the second visual code (11) on the cylinder (T) bought by means of a reader (for example, an application in his mobile phone) to check whether the first visual code (6) and the second visual code (11) match. If they match, it means that the cylinder (T) is filled in an authorized plant, and if they do not match, it means that the cylinder (T) is filled in an unauthorized manner.

In an illustrative embodiment of the invention, the said first visual code (6) and/or the second visual code (11) are in the form of a barcode. However, due to a limited number of barcodes to be produced specific to the cylinder (T) and absence of error correction data on the barcodes, it may not be preferred to use barcodes as the first visual code (6) and/or the second visual code (11). Therefore, in a preferred embodiment of the invention, the first visual code (6) and/or the second visual code (11) are two-dimensional codes. Since the number of two-dimensional codes to be produced specific to the cylinder (T) is higher than that of the barcodes and error correction data may be included inside the two-dimensional codes (for example, even if a part of the two-dimensional code is damaged, the two-dimensional code may be accurately decoded using the error correction data), using a two-dimensional code is more advantageous than using a barcode. Furthermore, since barcodes or two-dimensional codes are used as the first visual code (6) and/or the second visual code (6), the first visual code (6) and/or the second visual code (6) may, for example, be read using a mobile phone with camera. Thus, the users read the first visual code (6) and/or the second visual code (6) by means of their phones, when necessary, to obtain information about the cylinder (T).

In another preferred embodiment of the invention, the said identifier (5) is in the form of a plate (i.e. a sheet) connected to the collar (4). In this embodiment, the identifier (5) comprises at least one hole (9) for connecting to the collar (4). The said hole (9) is preferably located at the center of the identifier (5). In this embodiment, the identifier (5) in the form of a plate is preferably connected to the collar (4) by means of a rivet. Thus, the identifier (5) is practically and reliably connected to the collar (4). Moreover, thanks to the rivet connection, when the said identifier (5) is damaged, the identifier (5) is changed in an easy manner.

In another preferred embodiment of the invention, the said identifier (4) comprises at least two first visual codes (5). In this embodiment, if one of the first visual codes (5) is damaged or cannot be read accurately, the other first visual code (5) may be read.

In another preferred embodiment of the invention, the said identifier (5) comprises at least one serial number (7). If the first visual codes on the identifier are completely damaged, the serial number is inputted into the system manually or by OCR (optical character recognition) method so as to identify the cylinder.

In another preferred embodiment of the invention, the said cover (10) comprises at least one hologram sheath (not shown in the figures). The said hologram sheath complicates copying of the cover (10). In this embodiment, the second visual code (11) may be located on the hologram sheath or may be located under the hologram sheath. In an embodiment wherein the second visual code (11) is located under the hologram sheath, since the second visual code (11) can only be seen by the users, it is prevented to copy the second visual code (11) prior to sales of the cylinder (T).

In another preferred embodiment of the invention, the identifier (5) comprises at least one brand (8) information.

In the cylinder (T) according to the present invention, due to the fact that the identifier (5) is located at the inner side of the collar (4), the first visual code (6) on the identifier is prevented from being damaged, so that the identifier (5) is rendered more durable and long-lasting. Moreover, thanks to the second visual code (11) matched with the said first visual code (6), unauthorized filling of the cylinder (T) is also prevented.

1. A cylinder (T) comprising at least one body (1) in which a fluid fuel is stored; at least one valve (2) located on the body (1) for conveying fluid fuel into or from the body (1); at least one handle (3) located on the body (1); at least one collar (4) connecting the said handle (3) to the body (1); and at least one cover (10) on the said valve (2); characterized by comprising:
at least one identifier (5) located on the said collar (4) and having thereon at least a first visual code (6), which is in the form of a barcode or a two-dimensional code, specific to the cylinder it is connected;
at least a second visual code (11) which is in the form of barcode or a two-dimensional code and located on the said cover (10)
wherein, said second visual code (11) is in the form of a code to be matched with the first visual code (6) and different from the first visual code (6).

2. A cylinder (T) according to claim 1, characterized in that said at least one identifier (5) is located at the inner side of the collar (4).

3. A cylinder (T) according to claim 1, characterized in that the said handle (3) is located at the periphery of the valve (2).

4-5. (canceled)

6. A cylinder (T) according to claim 1, characterized in that said at least one identifier (5) is in the form of a plate connected to the collar (4).

7. A cylinder (T) according to claim 6, characterized in that said at least one identifier (5) comprises at least one hole (9).

8. A cylinder (T) according to claim 7, characterized in that the said hole (9) is located at the center of the identifier (5).

9. A cylinder (T) according to claim 1, characterized in that said at least one identifier (5) comprises at least two first visual codes (6).

10. A cylinder (T) according to claim 1, characterized in that said at least one identifier (5) comprises at least one serial number (7).

11. A cylinder (T) according to claim 1, characterized in that said at least one identifier (5) comprises at least one brand (8) information.

12-13. (canceled)

14. A cylinder (T) according to claim 1, characterized in that the said cover (10) comprises at least one hologram sheath.

15. A cylinder (T) according to claim 14, characterized in that the second visual code (11) is located on the hologram sheath.

16. A cylinder (T) according to claim 14, characterized in that the second visual code (11) is located under the hologram sheath.
